(19) United States
(12) Patent Application Publication
(10) Pub. No.: US 2021/0274791 A1
(43) Pub. Date: Sep. 9, 2021

(54) COMPOSITIONS AND METHODS TO TREAT CITRUS GREENING DISEASE

(71) Applicant: Marrone Bio Innovations, Inc., Davis, CA (US)

(72) Inventor: Pamela G. Marrone, Davis, CA (US)

(73) Assignee: Marrone Bio Innovations, Inc., Davis, CA (US)

(21) Appl. No.: 16/325,120

(22) PCT Filed: May 18, 2017
(86) PCT No.: PCT/US2017/033284

§ 371 Date: Feb. 12, 2019

Related U.S. Application Data
(60) Provisional application No. 62/414,870, filed on Oct. 31, 2016.

(51) Int. Cl. A01N 63/34; A01N 63/38; A01G 7/06; A01N 25/06; A01N 25/14; A01N 25/30

(52) U.S. Cl. CPC A01N 63/34; A01N 63/38; A01N 25/30; A01N 25/06; A01N 25/14; A01G 7/06

(57) ABSTRACT

The present disclosure includes the field of agricultural biologicals, and provides microorganism compositions for preventing and controlling citrus huanglongbing and their methods of use thereof.

### CROSS-REFERENCE TO RELATED APPLICATIONS

This application claims priority to, and is the National Stage of International Application No. PCT/US2017/033284 filed on May 18, 2017 and claims the priority of U.S. Provisional Patent Application Ser. No. 62/414,870, filed Oct. 31, 2016, the contents of which are incorporated by reference herein in their entirety.

### TECHNICAL FIELD OF THE INVENTION

The present disclosure provides compositions and methods for inhibiting Candidatus liberibacter infection or Huanglongbing disease. More specifically, the present disclosure relates to plant defense inducer compositions and compounds, and to their use for improving certain aspects of plant and crop management, including treating plant disease, improving the ability of plants to defend against disease, reducing disease symptoms, treating HLB disease, minimizing crop yield decreases due to plant disease, improving crop productivity, and increasing crop quality. In particular, the compounds and compositions can be used for controlling and treating plant disease, for example Huanglongbing disease (HLB) and mitigating disease symptoms of HLB and C. liberibacter infection in plants. Crop plants are contemplated for use with the disclosure, for example citrus trees.

### STATEMENT OF FEDERALLY FUNDED RESEARCH

None.

### INCORPORATION BY REFERENCE OF MATERIALS FILED ON COMPACT DISC

None.

### BACKGROUND OF THE INVENTION

Huanglongbing (HLB), commonly known as citrus “greening” disease, is caused by a partially systemic bacterial infection of trees and other crop species, leading to leaf discoloration and reduced fruit production. In Florida, the spread of the invasive HLB disease presents a major threat to the citrus industry, whose loses due to this infection have reached millions of dollars per year. Since the insect vector has reached Texas and California, it is only a matter of time until the disease breaks out in those states as well.

HLB has been associated with infections from three liberibacter species: Candidatus Liberibacter asiaticus (Las) for the disease in Asia, Candidatus Liberibacter africanus (Laf) for the disease in Africa, and Candidatus Liberibacter americanus (Lam), for the disease in the Americas. Together are called Candidatus Liberibacter spp.

The current management strategy of HLB is to chemically control psyllids and scout for and remove infected trees. Its efficacy is limited and no conventional measure has shown to provide consistent and effective suppression of the disease.

The fruit of HLB infected trees is quite bitter. The color of the fruit will stay green even when it is ripe and its size is small. Trees with HLB disease will lose their leaves, and will wither and die before long. High cost of frequent insect control and tree removal will eventually render citrus groves unprofitable, which causes heavy damage to horticulture and agriculture. And large scale application of insecticides will disrupt the ecosystem and pollute the environment.

Thus, there is a need to effectively treat HLB disease.

### SUMMARY OF THE INVENTION

Techniques and compositions are provided for improving the health and disease resistance of plants, including important crop plants such as citrus. The methods also provide treatment and control of plant diseases in plants affected or susceptible to the disease. The microbial based compositions according to embodiments of the disclosure described here can be applied to plants to treat a plant disease, such as HLB, improve resistance to disease, improve the ability to defend against disease, reduce disease symptoms, minimize decreases in crop yield due to a plant disease, improve crop productivity and crop quality in citrus, and increase juice content and juice quality in citrus. Therefore, the microbial-based compositions can be used to benefit healthy plants and diseased plants. The methods described also involve application of the compositions to the plant, including application to the soil around the plant by injection or soil drench methods, application to the surface of the plant, such as by spraying onto the plant or parts of the plant, such as by foliar spraying, or injection into the plant such as by trunk injection. Plants for which the disclosure is contemplated include any plant, particularly crop plants, but including ornamental plants and citrus plants as well.

In an aspect, the present disclosure relates in the field of bio-pesticide treating citrus greening disease. More particularly, this invention relates to the finding of strains of Aspergillus ochraceus, Trichoderma virens or Trichoderma harzianum that can inhibit the growth of Candidatus Liberibacter spp. when applying the fermented whole cell broth, filtrate, supernatant, or extracts to plant, plant parts and/or fruits.

In another aspect, this invention relates to the finding of strains of Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) that can inhibit the growth of Candidatus Liberibacter spp. when applying the fermented whole cell broth, filtrate, supernatant, or extracts to plant, plant parts and/or fruits.

In one aspect, the present disclosure relates to a method to control citrus greening disease with the filtrate of fermentation product of bacteria strain include, but are not limited to: Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415), with concentrations as low as 1% to show effective inhibition of citrus greening disease.

In one aspect, the singular, or the mixture of the fungi can be applied to plant, substrates, plant parts, fruits, or plant roots to control the HLB disease.

In another aspect, the present disclosure relates to a first embodiment (embodiment number 1) including a citrus greening disease control composition comprising whole cell broth, filtrate, or supernatant collected from Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) fermentation.

In another aspect, the present disclosure relates to citrus greening disease control compositions comprising whole cell broth, filtrate, or supernatant collected from Aspergillus ochraceus (ATCC 18412), or Trichoderma virens fermentation.

In an aspect, a seed, plant parts, roots, or fruits comprising the composition of embodiment 1 above is contemplated.

Yet in another aspect, embodiment 1 can be present in a formulation selected from the group consisting of an emulsifiable concentrate, a wettable powder, a soluble liquid, an aerosol, an ultra-low volume concentrate solution, a soluble powder, a microencapsulate, water-dispersed granules, a flowable, a micro emulsion and a nano-emulsion.

The present disclosure also relates to an aspect of a method to control citrus greening disease in a plant comprising applying to the plant, plant parts, seed and/or substrate from the plant, an amount of composition of embodiment 1, effective to control said citrus greening disease. Alternative, the composition of embodiment 1 is administered through being introduced into the xylem or phloem.

Yet in an aspect, the method further comprising transplanting said plant into said growth substrate.

Yet in another aspect, the plant is a citrus plant.

In another aspect, the fungal strains of Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) can be dead or lysed by chemical reagents or by heat. Alternatively, they can be dead by heat-killed method.

In an aspect, the composition of embodiment 1 can further include a plant fertilizer or one or more reagent having nematicidal, fungicidal or insecticidal activity.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “applying,” “application,” “administering,” “administration,” and all their cognates, as used herein, refers to any method for contacting the plant with the microbial-based compositions discussed herein. Administration generally is achieved by application of the compositions in a vehicle compatible with the plant to be treated (i.e., a botanically compatible vehicle or carrier), such as an aqueous vehicle, to the plant or to the soil surrounding the plant or by injection into the plant. Any application can be used, however one application methods include trunk injection and foliar spraying as described herein. Other methods include application to the soil surrounding the plant, by injection, soaking or spraying, so that the applied compounds can come into contact with the plant roots and can be taken up by the roots.

As defined herein, “derived from” means directly isolated or obtained from a particular source or alternatively having identifying characteristics of a substance or organism isolated or obtained from a particular source. In the event that the “source” is an organism, “derived from” means that it may be isolated or obtained from the organism itself or from the medium used to culture or grow said organism.

The term “Citrus”, as used herein, refers to any plant of the genus Citrus, family Rutaceae, and includes Citrus maxima (Pomelo), Citrus medica (Citron), Citrus micrantha (Papeda), Citrus reticulata (Mandarin orange), Citrus trifolata (trifoliate orange), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera); Citrus indica (Indian wild orange), Citrus macroptera, and Citrus latipes. Hybrids also are included in this definition, for example Citrus.times.aurantiifolia (Key lime), Citrus.times.aurantium (Bitter orange), Citrus.times.latifolia (Persian lime), Citrus.times.limon (Lemon), Citrus.times.limonia (Rangpur), Citrus.times.paradisi (Grapefruit), Citrus.times.sinensis (Sweet orange), Citrus.times.tangerina (Tangerine), Poncirus trifoliata.times.C. sinensis (Carrizo citrange), and any other known species or hybrid of genus Citrus. Citrus known by their common names include, Imperial lemon, tangelo, orangelo, tangor, kinnow, kiyomi, Minneola tangelo, oroblanco, sweet orange, ugli, Buddha's hand, citron, lemon, orange, bergamot orange, bitter orange, blood orange, calamondin, clementine, grapefruit, Meyer lemon, Rangpur, tangerine, and yuzu, and these also are included in the definition of citrus or Citrus.

The term “effective amount” or “therapeutically effective amount,” as used herein, means any amount of the compound or composition which serves its purpose, for example, treating plant disease, improving the ability of plants to defend against disease, reducing disease symptoms, treating HLB disease, minimizing crop yield decreases due to plant disease, improving crop productivity, and increasing crop quality.

As defined herein, “whole cell broth” refers to a liquid culture containing cells, spores and/or media. If bacteria or fungi are grown on a plate the cells can be harvested in water or other liquid or whole culture.

The term “supernatant” refers to the liquid remaining when cells that are grown in broth or harvested in another liquid from an agar plate are removed by centrifugation, sedimentation, or other means known in the art.

As defined herein, “filtrate” refers to liquid from a whole broth culture that has passed through a membrane. A non-limiting way to form a filtrant is to ferment one or more microorganism to create a whole cell broth, then pass the broth through a membrane, where the filtrant is cell-free.

As defined herein, “extract” refers to liquid substance removed from cells by a solvent (water, detergent, buffer) and separated from the cells by centrifugation, filtration or other method.

As defined herein, “metabolite” refers to a compound, substance or byproduct of a fermentation of a microorganism, or supernatant, filtrate, or extract obtained from a microorganism which can be bacterial or fungal.

As defined herein, an “isolated compound” is essentially free of other compounds or substances, e.g., at least about 20% pure, preferably at least about 40% pure, more preferably about 60% pure, even more preferably about 80% pure, most preferably about 90% pure, and even most preferably about 95% pure, as determined by analytical methods, including but not limited to chromatographic methods and electrophoretic methods.

A “carrier” as defined herein is an inert, organic or inorganic material (e.g., water), with which the active ingredient is mixed or formulated to facilitate its application to plant or other object to be treated, or its storage, transport and/or handling.

The terms “control” or “modulate” as defined herein are used to mean to alter the amount of HLB infection or rate of spread of HLB. For example, inhibit the HLB infection or rate of spread, or to prevent HLB infection.

As defined herein, “inactivated” microorganism refers to dead microbes, or microbes not in the active growing stage (e.g., spores). Non-limiting ways of inactivation include heat-killed or chemical killed. In one embodiment, the microbes can be lysed.

In one embodiment, the culture supernatants or filtrate derived from fermented broth cultures of the fungal compositions collected from Aspergillus ochraceus, Trichoderma virens or Trichoderma harzianum were tested for the inhibition of the citrus green disease bacteria.

In another embodiment, the cultured whole cell broth, supernatants or filtrate derived from fermented broth cultures of the fungal compositions collected from Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) were tested for the inhibition of the citrus green disease bacteria.

The fungi disclosed herein can be cultivated in nutrient medium using methods known in the art. The organisms can be cultivated by shake flask cultivation, small scale or large scale fermentation (including but not limited to continuous, batch, fed-batch, or solid state fermentations) in laboratory or industrial fermenters performed in suitable medium and under conditions allowing cell growth. The cultivation can take place in suitable nutrient medium comprising carbon and nitrogen sources and inorganic salts, using procedures known in the art. Suitable media are available from commercial sources or can be prepared according to published articles.

The fungal compositions can be applied using methods known in the art. Specifically, these compositions can be applied to and around plants or plant parts. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds. Treatment of the plants and plant parts with the compositions set forth above can be carried out directly or by allowing the compositions to act on their surroundings, habitat or storage space by, for example, immersion, spraying, evaporation, fogging, scattering, painting on, injecting. In the case that the composition is applied to a seed, the composition can be applied to the seed as one or more coats prior to planting the seed, or applied as a slurry or dust when planting, using one or more coats using methods known in the art. The seed in a particular embodiment may be a genetically modified seed.

The compositions disclosed herein can be formulated for seed treatments in any of the following modes: dry powder, water slurriable powder, liquid solution, flowable concentrate or emulsion, emulsion, microcapsules, gel, or water dispersible granules.

In the case of a dry powder, the active ingredient can be formulated similarly to a wettable powder, but with the addition of a sticking agent, such as mineral oil, instead of a wetting agent. For example, one kg of purified talc powder (sterilized for 12 h), 15 g calcium carbonate, and 10 g carboxymethyl cellulose are mixed under aseptic conditions following the method described by Nandakumar et al (2001). Active ingredient(s) is/are mixed in a 1:2.5 ratio (suspension to dry mix) and the product is shade dried to reduce moisture content to 20-35%.

In one embodiment, the compositions can comprise whole cell broth cultures, liquid cultures, filtrants, or suspensions collected from strains from Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) fermentation.

The compositions set forth above can be formulated in any manner. Non-limiting formulation examples include, but are not limited to, Emulsifiable concentrates (EC), Wettable powders (WP), soluble liquids (SL), Aerosols, Ultra-low volume concentrate solutions (ULV), Soluble powders (SP), Microencapsulation, Water dispersed Granules, Flowables (FL), Microemulsions (ME), Nano-emulsions (NE), etc. In any formulation described herein, percent of the active ingredient is within a range of 0.01% to 99.99%.

The compositions can also be chosen from a number of formulation types, including dustable powders (DP), soluble powders (SP), water soluble granules (SG), water dispersible granules (WG), wettable powders (WP), granules (GR) (slow or fast release), soluble concentrates (SL), oil miscible liquids (OL), ultra-low volume liquids (UL), emulsifiable concentrates (EC), dispersible concentrates (DC), emulsions (both oil in water (EW) and water in oil (EO)), micro-emulsions (ME), suspension concentrates (SC), oil-based suspension concentrate (OD), aerosols, fogging/smoke formulations, capsule suspensions (CS) and seed treatment formulations. The formulation type chosen in any instance depend upon the particular purpose envisaged and the physical, chemical and biological properties of the fungi.

The compositions can also be in the form of a liquid, gel or solid. A solid composition can be prepared by suspending a solid carrier in a solution of active ingredient(s) and drying the suspension under mild conditions, such as evaporation at room temperature or vacuum evaporation at 65° C. or lower. A composition can comprise gel-encapsulated active ingredient(s). Such gel-encapsulated materials can be prepared by mixing a gel-forming agent (e.g., gelatin, cellulose, or lignin) with a culture or suspension of live or inactivated fungi or a cell-free filtrate or cell fraction of a fungal culture or suspension, or a spray- or freeze-dried culture, cell, or cell fraction or in a solution of antibacterial compounds used in the method of the invention; and inducing gel formation of the agent.

The composition can additionally comprise a surfactant to be used for the purpose of emulsification, dispersion, wetting, spreading, integration, disintegration control, stabilization of active ingredients, and improvement of fluidity or rust inhibition. In a particular embodiment, the surfactant is a non-phytotoxic non-ionic surfactant which preferably belongs to EPA List 4B (incorporated herein by reference). In another particular embodiment, the nonionic surfactant is polyoxyethylene (20) monolaurate. The concentration of surfactants may range between 0.1-35% of the total formulation, preferred range is 5-25%. The choice of dispersing and emulsifying agents, such as non-ionic, anionic, amphoteric and cationic dispersing and emulsifying agents, and the amount employed is determined by the nature of the composition and the ability of the agent to facilitate the dispersion of the compositions of the present disclosure.

The compositions can also include, but are not limited to, aminoglycoside antibiotics which include a number of molecules (e.g. kanamycin, neomycin, gentamycin, derivative G418 and paromycin) which are toxic to plant, fungal and animal cells (Nap et al. 1992) as well as bacterial neomycin phosphotransferase II and aerocyanidin, aerocavin, 3,6-dihydroxy-indoxazene, and monobactam SB-26.180.

As noted above, the compositions and substances set forth above can be used to modulate the amount of Candidatus Liberibacter spp. infestation in plants, their seeds, roots, fruits, foliage, stems, tubers, and in particular, inhibit and/or prevent said Candidatus Liberibacter spp. infection, in particular, decrease the rate and/or degree of spread of said Candidatus Liberibacter spp. infection in said plants. Again, the plants include but are not limited to fruits (e.g., strawberry, blueberry, blackberry, peach and other stone fruits), vegetable (e.g., tomato, squash, pepper, eggplant, potatoes, carrots), or grain crops (e.g., soy, wheat, rice, corn, sorghum), trees, flowers, ornamental plants, shrubs (e.g., cotton, roses), bulb plants (e.g., onion, garlic) or vines (e.g., grape vine), turf, tubers (e.g. potato, carrots, beets). Alternatively, said compositions can be used to modulate the amount of Candidatus Liberibacter spp. infection in plants and in particular, prevent or inhibit said Candidatus Liberibacter spp. infection and/or decrease the rate and/or degree of spread of said disease infection in said plants. Again, the plants include but are not limited to (e.g., strawberry), vegetable (e.g., tomato, squash, pepper, eggplant), or grain crops (e.g., soy, wheat, rice, corn), trees, flowers, ornamental plants, shrubs (e.g., cotton, roses), bulb plants (e.g., onion, garlic) or vines (e.g., grape vine).

In another embodiment, delivery of the composition to plants can be via different routes. The compositions can be suitably administered as an aerosol, for example by spraying onto leaves or other plant material. The particles can also be administered by injection, for example directly into a plant, such as into the stem. In certain embodiments the compositions are administered to the roots. This can be achieved by spraying or watering plant roots with compositions. In other embodiments, the particles are introduced into the xylem or phloem, for example by injection or being included in a water supply feeding the xylem or phloem.

The compositions disclosed herein can also be used in combination with seed-coating agents. Such seed coating agents include, but are not limited to, ethylene glycol, polyethylene glycol, chitosan, carboxymethyl chitosan, peat moss, resins and waxes or chemical fungicides or bactericides with either single site, multisite or unknown mode of action.

In another embodiment, the compositions of the present disclosure can be applied by cutting the tips of the plant roots and dip them in the fermented whole cell broth, filtrate, supernatant, or extracts at different concentration of Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) fermentation.

The composition set forth herein can be combined with another microorganism and/or pesticide (e.g, nematicide, fungicide, insecticide). The microorganism may include but is not limited to an agent derived from Bacillus sp. (e.g., Bacillus firmus, Bacillus thuringiensis, Bacillus pumilus, Bacillus licheniformis, Bacillus amyloliquefaciens, Bacillus subtilis), Paecilomyces sp. (P. lilacinus), Pasteuria sp. (P. penetrans), Pseudomonas sp., Brevabacillus sp., Lecanicillium sp., Ampelomyces sp., Pseudozyma sp., Streptomyces sp (S. bikiniensis, S. costaricanus, S. avermitilis), Burkholderia sp., Trichoderma sp., Gliocladium sp., avermectin, Myrothecium sp., Paecilomyces spp., Sphingobacterium sp., Arthrobotrys sp., Chlorosplrnium, Neobulgaria, Daldinia, Aspergillus, Chaetomium, Lysobacter spp, Lachnum papyraceum, Verticillium suchlasporium, Arthrobotrys oligospora, Verticillium chlamydosporium, Hirsutella rhossiliensis, Pochonia chlamydosporia, Pleurotus ostreatus, Omphalotus olearius, Lampteromyces japonicas, Brevudimonas sp., or Muscodor sp.

Alternatively, the composition can be combined with a natural oil or oil-product having nematicidal, fungicidal and/or insecticidal activity (e.g., paraffinic oil, tea tree oil, lemongrass oil, clove oil, cinnamon oil, citrus oil including but not limited to bitter orange, orange, lemon; rosemary oil, pyrethrum, allspice, bergamot, blue gum, camomile, citronella, common jasmine, common juniper, common lavender, common myrrh, field mint, freesia, gray santolina, herb hyssop, holy basil, incense tree, jasmine, lavender, marigold, mint, peppermint, pot marigold, spearmint, ylang-ylang tree, saponins). Furthermore, the composition can be added with a single site anti-fungal agent which can include, but is not limited to, benzimidazole, a demethylation inhibitor (DMI) (e.g., imidazole, piperazine, pyrimidine, triazole), morpholine, hydroxypyrimidine, anilinopyrimidine, phosphorothiolate, quinone outside inhibitor, quinoline, dicarboximide, carboximide, phenylamide, anilinopyrimidine, phenylpyrrole, aromatic hydrocarbon, cinnamic acid, hydroxyanilide, antibiotic, polyoxin, acylamine, phthalimide, benzenoid (xylylalanine), a demethylation inhibitor selected from the group consisting of imidazole, piperazine, pyrimidine and triazole (e.g., bitertanol, myclobutanil, penconazole, propiconazole, triadimefon, bromuconazole, cyproconazole, diniconazole, fenbuconazole, hexaconazole, tebuconazole, tetraconazole), myclobutanil, and a quinone outside inhibitor (e.g., strobilurin). The strobilurin can include, but is not limited, to azoxystrobin, kresoxim-methoyl or trifloxystrobin. In yet another particular embodiment, the anti-fungal agent is a quinone, e.g., quinoxyfen (5,7-dichloro-4-quinolyl 4-fluorophenyl ether). The anti-fungal agent can also be derived from a Reynoutria extract.

Administration Methods

Persons of skill are aware of various methods to apply microbial-based compositions, to plants for surface application or for uptake, and any of these methods are contemplated for use in this disclosure. Methods of administration to plants include, by way of non-limiting example, application to any part of the plant, by inclusion in irrigation water, by injection into the plant or into the soil surrounding the plant, by exposure of the root system to aqueous solutions containing the compounds, by use in hydroponic or aeroponic systems, by culture of individual or groups of plant cells in media containing the inducer, by seed treatment, by exposure of cuttings of citrus plants used for grafting to aqueous solutions containing the compounds, by application to the roots, stems or leaves, or by application to the plant interior, or any part of the plant to be treated. Any means known to those of skill in the art is contemplated. One mode of administration include those where the compositions are applied at, on or near the roots of the plant, or trunk injection.

Application of microbial-based compositions can be performed in a nursery setting, a greenhouse, hydroponics facility, or in the field, or any setting where it is desirable to treat plants to prevent the likelihood of disease, or to treat disease and its effects, for example in plants which have been or can become exposed to HLB or Ca. liberibacter infection. The methods and compounds of this disclosure can be used to treat infection with any Ca. liberibacter species or type and can be used to improve plant defenses in plants which are not infected. Thus, any plant in need, in the context of this disclosure, includes any and all plants for which improvements in health and vigor, growth and productivity or ability to combat disease is desired. Citrus or other plants susceptible to diseases such as HLB or infection by Ca. liberibacter species, whether currently infected or in potential danger of infection.

Application to seeds can be accomplished as follows, however any method known in the art can be used. Seeds can be treated or dressed prior to planting, by soaking the seeds in a solution containing the compounds at a dosage of active ingredient over a period of minutes or hours, or by coating the seeds with a carrier containing the compounds at a dosage of active ingredient. The concentrations, volumes, and duration may change depending on the plant.

Application to soil can be performed by soil injection or soil drenching, however any method known in the art can be used. These methods of administration are accomplished as follows. Soil drenching can be performed by pouring a solution or vehicle containing the compounds at a dosage of active ingredient at 0.5 to 1 gallons/tree to the soil surface in a crescent within 10 to 100 cm of the trunk on the top side of the bed to minimize runoff, and/or by using the irrigation system. Soil injection can be performed by directly injecting a solution or vehicle containing the compounds at a dosage of active ingredient into the soil within 10 to 100 cm of the trunk using a soil injector. The concentrations, volumes, and duration may change depending on the plant.

Application to hydroponic or culture media can be performed as follows, however any method known in the art can be used. A solution or vehicle containing the compounds at a dosage of active ingredient may be added into the hydroponic or culture media at final concentrations suitable for plant growth and development. The concentrations, and volumes may change depending on the plant.

Application to the roots can be performed by immersing the root structure in a solution or vehicle in a laboratory, nursery or hydroponics environment, or by soil injection or soil drenching to the soil surrounding the roots, as described above. Emersion of the root structure can be performed as follows, however any method known in the art can be used. A solution or vehicle containing the compounds at a dosage of active ingredient may be applied to the roots by using a root feeder at 0.5 to 1 gallons per tree. The concentrations, volumes, and duration can change depending on the plant.

Application to the stems or leaves of the plant can be performed by spraying or other direct application to the desired area of the plant, however any method known in the art can be used. A solution or vehicle containing the compounds at a dosage of active ingredient can be applied with a sprayer to the stems or leaves until runoff to ensure complete coverage, and repeat three or four times in a growing season. The concentrations, volumes and repeat treatments may change depending on the plant.

In the present disclosure, the following surfactant can be used together with the above-mentioned microorganism fermentation to promote emulsification, dispersion, solubilization and permeation.

Non-limiting examples of nonionic surfactants include sorbitan fatty acid esters, polyoxyalkylene sorbitan fatty acid esters, polyoxyalkylene fatty acid esters, glycerol fatty acid esters, polyoxyalkylene glycerol fatty acid esters, polyglycerol fatty acid esters, polyoxyalkylene polyglycerol fatty acid esters, sucrose fatty acid esters, resin acid esters, polyoxyalkylene resin acid esters, polyoxyalkylene alkyl ethers, polyoxyalkylene alkylphenyl ethers, alkyl(poly)glycosides and polyoxyalkylenealkyl(poly)glycosides. Preferably, an ether group-containing nonionic surfactant having no nitrogen atom and ester group-containing nonionic surfactant can be used.

Non-limiting examples of anionic surfactants include carboxylic, sulfonic, sulfuric ester group-containing and phosphoric ester group-containing surfactants, and a carboxylic and phosphoric ester group-containing surfactants.

Non-limiting examples of the carboxylic surfactants include fatty acids having 6-30 carbon atoms or salts thereof, polyhydric carboxylic acid salts, polyoxyalkylene alkyl ether carboxylic acid salts, polyoxyalkylene alkylamide ether carboxylic acid salts, rhodinic acid salts, dimmer acid salts, polymer acid salts and tall oil fatty acid salts.

Non-limiting examples of the sulfonic surfactants include alkylbenezenesulfonic acid salts, alkylsulfonic acid salts, alkylnaphthalenesulfonic acid salts, naphthalenesulfonic acid salts, diphenyl ether sulfonic acid salts, condensates of alkylnaphthalenesulfonic acid, and condensate of naphthalenesulfonic acid.

Non-limiting examples of the sulfuric ester group-containing surfactants include alkylsulfuric ester salts (alkylsulfuric acid salts), polyoxyalkylene alkylsulfuric ester salts (polyoxyalkylene alkylsulfuric acid salts), polyoxyalkylene alkyl phenyl ether sulfuric acid salts, tristyrenatedphenol sulfuric acidester salts, polyoxyalkylene distyrenated phenol sulfuric acid ester salts and alkylpolyglycoside sulfuric acid salts.

Non-limiting examples of phosphoric acid ester group-containing surfactants include alkyl phosphoric acid ester salts, alkylphenylphosphoric acid ester salts, polyoxyalkylene alkylphosphoric acid ester salts and polyoxyalkylene alkylpheneylphosphoric acid ester salts.

Non-limiting examples of the salts include metallic salts (such as salts of Na, K, Ca, Mg and Zn), ammonium salts, alkanol amine salts and aliphatic amine salts.

Non-limiting examples of amphoteric surfactants include amino acid group-containing, betaine group-containing, imidazoline group-containing and amine oxide group-containing surfactants.

Non-limiting examples of the amino acid group-containing surfactants include acylamino acid salts, acylsarcosine acid salts, acyloylmethylaminopropionic acid salts, alkylaminopropionic acid salts and acylamide ethylhydroxyethylmethylcarboxylic acid salts.

Non-limiting examples of the betaine group-containing surfactants include alkyl dimethylbetaine, alkylhydroxyethylbetaine, acylamide propylhydroxypropylammonia sulfobetaine, acylamide propylhydroxypropylammonia sulfobetaine and ricinoleic acid amide propyl dimethylcarboxy methylammonia betaine.

Non-limiting examples of the imidazoline group-containing surfactants include alkylcarboxy methylhydroxy ethylimidazolinium betaine and alkylethoxy carboxy methylimidazolinium betaine.

Non-limiting examples of the amine oxide group-containing surfactants include alkyldimethylamine oxide, alkyldiethanolamine oxide and alkylamidepropylamine oxide.

One kind of the above-mentioned surfactants may be used, and a mixture of two or more kinds of the above-mentioned surfactants can be used. In the case that one of these surfactants comprises a polyoxyalkylene group, the polyoxyalkylene group can be a polyoxyethylene group and the average mole number of added polyoxyethylene groups can be from 1 to 50.

As the surfactant, at least one compound selected from ester group-containing nonionic surfactants, ether group-containing nonionic surfactants having no nitrogen atom, amphoteric surfactants, carboxylic anionic surfactants and phosphoric anionic surfactant can be used.

The following fertilizer components may be used together with the above-mentioned microorganism fermentation. Specific examples thereof can be inorganic or organic compounds which can supply elements such as N, P, K, Ca, Mg, S, B, Fe, Mn, Cu, Zn, Mo, Cl, Si and Na, in particular N, P, X, Ca and Mg. Examples of such inorganic compounds include ammonium nitrate, potassium nitrate, ammonium sulfate, ammonium chloride, ammonium phosphate, sodium nitrate, urea, ammonium carbonate. potassium phosphate, calcium superphosphate, fused phosphate fertilizer (3MgO.CaO.P₂O₅.3CaSiO₂), potassium sulfate, potassium chloride, nitrate of lime, slaked lime, carbonate of lime, magnesium sulfate, magnesium hydroxide and magnesium carbonate. Examples of the organic compounds include fowl droppings, cow dung, Bark compost, amino acid, peptone, amino acid solution, fermentation extracts, calcium salts of organic acids (such as citric acid, gluconic acid and succinic acid), and calcium salts of fatty acids (such as formic acid, acetic acid, propionic acid, caprylic acid, capric acid and caproic acid). These fertilizer components may be used together with the surfactant. In the case that fertilizer components are sufficiently applied as basal fertilizer to soil as seen in outdoor cultivation of a rice-plant or vegetables, it is unnecessary to mix the fertilizer components.

### EXAMPLES

### Example 1

Because Candidatus Liberibacter spp. does not grow in vitro outside of an infected plant, Liberibacter crescens is used as an in vitro model known in art as indication of HLB inhibition.

In this assay each antimicrobial compound were tested by growing the L. crescens bacteria in the presence of candidate microbial filtrates (cell free) at different concentrations for 2 days in order to see which antimicrobials and which concentrations inhibit the growth. The amount of growth was quantified by incubating the bacteria/antimicrobial mixture with PrestoBlue Cell Viability Reagent, a fluorophore that changes from blue and non-fluorescent in red and highly fluorescent in the presence of live cells. This change in fluorescence was detected using a fluorescence microplate reader and are shown in Table 1.

TABLE 1

| | Concentration | % |
|---|---|---|
| Sample | (%) | Inhibition |
| Aspergillus ochraceus | 0.5 | 86.94 |
| (ATCC 18412) | 0.1 | 66.80 |
| | 0.05 | 24.40 |
| Trichoderma virens | 0.5 | 89.93 |
| S101 (NRRL 67411) | 0.1 | 27.95 |
| | 0.05 | 22.03 |
| Trichoderma virens | 0.5 | 92.79 |
| S102 (NRRL 67412) | 0.1 | 30.85 |
| | 0.05 | 12.11 |
| Trichoderma virens | 0.5 | 78.53 |
| S103 (67413) | 0.1 | 37.30 |
| | 0.05 | −4.66 |
| Trichoderma harzianum | 0.5 | 100.49 |
| S117 (NRRL 67415) | 0.1 | 85.37 |
| | 0.05 | 50.17 |
| Trichoderma harzianum | 0.5 | 52.13 |
| S117 (NRRL 67415) | 0.1 | −18.05 |
| | 0.05 | −8.62 |

Although some of the sample contain the same genus-species name, they are different strains of the same species.

In addition, higher concentrations up to 25% were also tested (not shown), and exhibits >95% inhibition on average.

### Example 2

Greenhouse Assay

One year-old single-stem citrus trees that are five to eight month post-grafting and not treated with systemic insecticide will be used for the assay. The trees are provided in pots large enough so not to become root-bound during the duration of this assay. Trees are kept in a psyllid-free greenhouse and were delivered when beginning to be actively flushing. Trees are placed in a growth room with C. Las-infested Diaphorina citri until trees are uniformly infected. A sub-sample of psyllids are collected following plant inoculations to confirm the C. Las infestation rate of the insects. The psyllids are then physically removed and insecticidal soap are applied to the trees before moving to a psyllid-free greenhouse.

Prior to treatment, four leaves are removed from each tree, two from each side of the apex of the tree and two from each side of the base of the canopy, for initial titer (T0) using qPCR. Trees are then treated with fermented Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) whole cell broth or filtrants by foliar sprays, soil drench or by root infusion. Antimicrobial materials that have been previously shown not to enter the phloem by a foliar application are assayed by root infusion.

For root infusions, one lateral root from each plant are separated, but kept attached to the main root system. This intact root are used after gently cleaning the lateral root of medium, cutting the root tip under sterile distilled water, and placing the cut tip into plastic tubing. Materials are injected into the tube and allowed to infuse into the tree. Thirty days post-treatment, four leaves are removed from similar locations as the T0 samples and used to monitor movement of the antimicrobial materials. The assay consist of ten infected/treated and ten healthy/treated, there are also ten healthy untreated and ten infected untreated. Phytotoxicity are evaluated in the healthy/treated trees and were determined by leaf drop, leaf burning and discoloration compared to the healthy/untreated controls. qPCR are conducted and show inhibition of C. Liberibacter infection in plants.

Deposit of Biological Material

The following biological material has been deposited under the terms of the Budapest Treaty with the Agricultural Research Culture Collection (NRRL), 1815 N. University Street, Peoria, Ill. 61604, USA, and given the following number:

| Deposit | Accession Number | Date of Deposit |
|---|---|---|
| Trichoderma virens S101 | (NRRL 67411) | Mar. 30, 2017 |
| Trichoderma virens S102 | (NRRL 67412) | Mar. 30, 2017 |
| Trichoderma virens S103 | (NRRL 67413) | Mar. 30, 2017 |
| Trichoderma virens S090 | (NRRL 67414) | Mar. 30, 2017 |
| Trichoderma harzianum S117 | (NRRL 67415) | Mar. 30, 2017 |

The strain has been deposited under conditions that assure that access to the culture will be available during the pendency of this patent application to one determined by the Commissioner of Patents and Trademarks to be entitled thereto under 37 C.F.R. § 1.14 and 35 U.S.C. § 122. The deposit represents a substantially pure culture of the deposited strain. The deposit is available as required by foreign patent laws in countries wherein counterparts of the subject application, or its progeny are filed. However, it should be understood that the availability of a deposit does not constitute a license to practice the subject invention in derogation of patent rights granted by government action.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A citrus greening disease control fungal composition comprising (i) a whole cell broth or filtrant collected from Aspergillus ochraceus, Trichoderma virens or Trichoderma harzianum fermentation; and (ii) a carrier, diluent, adjuvant or surfactant.

2. A citrus greening disease control fungal composition comprising (i) a whole cell broth or filtrant collected from Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415) fermentation; and (ii) a carrier, diluent, adjuvant or surfactant.

3. A plant or plant parts comprising the composition of claim 1.

4. The composition of claim 1, wherein said fungal strain is present in a formulation selected from the group consisting of an emulsifiable concentrate, a wettable powder, a soluble liquid, an aerosol, an ultra-low volume concentrate solution, a soluble powder, a microencapsulate, water-dispersed granules, a flowable, a micro emulsion and a nano-emulsion.

5. The composition of claim 1, further comprising a plant fertilizer or one or more reagent having nematicidal, fungicidal or insecticidal activity.

6. A method to control citrus greening disease in a plant comprising:
applying to the plant, plant parts, seed and/or substrate from the plant, an amount of composition of claim 1, effective to control said citrus greening disease.

7. The method according to claim 6, further comprising transplanting said plant into said growth substrate.

8. The method of claim 6, wherein said plant is a citrus plant.

9. The method of claim 8, wherein said citrus is selected from the group consisting of Citrus maxima (Pomelo); Citrus medica (Citron); Citrus micrantha (Papeda); Citrus reticulata (Mandarin orange); Citrus trifolata (trifoliate orange); Citrus japonica (kumquat); Citrus australasica (Australian Finger Lime); Citrus australis (Australian Round lime); Citrus glauca (Australian Desert Lime); Citrus garrawayae (Mount White Lime); Citrus gracilis (Kakadu Lime or Humpty Doo Lime); Citrus inodora (Russel River Lime); Citrus warburgiana (New Guinea Wild Lime); Citrus wintersii (Brown River Finger Lime); Citrus halimii (limau kadangsa, limau kedut kera) Citrus indica (Indian wild orange); Citrus macroptera; and Citrus latipes; Citrus.times.aurantiifolia (Key lime); Citrus.times.aurantium (Bitter orange); Citrus.times.latifolia (Persian lime); Citrus.times.limon (Lemon); Citrus.times.limonia (Rangpur);Citrus.times.paradisi (Grapefruit), Citrus.times. sinensis (Sweet orange), Citrus.times.tangerina (Tangerine), Poncirus trifoliata.times.C. sinensis (Carrizo citrange), C. paradisi “Duncan” grapefruit.times.Pondirus trifoliate (Swingle citrumelo), Imperial lemon, tangelo, orangelo, tangor, kinnow, kiyomi, Minneola tangelo, oroblanco, sweet orange, ugli, Buddha's hand, citron, lemon, orange, bergamot orange, bitter orange, blood orange, calamondin, clementine, grapefruit, Meyer lemon; Rangpur; tangerine; and yuzu.

10. A method to control citrus greening disease in a plant comprising:
applying to the plant, plant parts, seed and/or substrate from the plant, an amount of composition of claim 5, effective to control said citrus greening disease.

11. The method according to claim 10, further comprising transplanting said plant into said growth substrate.

12. A substantially purified microorganism comprising Aspergillus ochraceus (ATCC 18412), Trichoderma virens S101 (NRRL 67411), Trichoderma virens S102 (NRRL 67412), Trichoderma virens S103 (NRRL 67413), Trichoderma virens S090 (NRRL 67414) or Trichoderma harzianum S117 (NRRL 67415).
